(19) United States
(12) Patent Application Publication
(10) Pub. No.: US 2026/0121158 A1
(43) Pub. Date: Apr. 30, 2026

(54) POWER STORAGE DEVICE

(71) Applicant: TOYOTA JIDOSHA KABUSHIKI KAISHA, Toyota-shi (JP)

(72) Inventor: Satoshi KANEKO, Nisshin-shi (JP)

(73) Assignee: TOYOTA JIDOSHA KABUSHIKI KAISHA, Toyota-shi (JP)

(21) Appl. No.: 19/309,995

(22) Filed: Aug. 26, 2025

(30) Foreign Application Priority Data
Oct. 28, 2024 (JP) 2024-189154

(51) Int. Cl. H01M 10/6556; H01M 10/613; H01M 10/615; H01M 10/625; H01M 10/653; H01M 10/6567; H01M 50/249; H01M 50/262

(52) U.S. Cl. CPC H01M 10/6556; H01M 10/613; H01M 10/615; H01M 10/625; H01M 10/653; H01M 10/6567; H01M 50/249; H01M 50/262

(57) ABSTRACT

A power storage device includes at least one power storage cell, a housing case that includes a lower case, and an upper case that is provided such that the lower case is covered from above, the housing case housing the at least one power storage cell, a heat exchanger that is disposed downward from the lower case, a shear panel that is disposed downward from the heat exchanger, a heat conductive member that is disposed in at least one of between the at least one power storage cell and the lower case, and between the heat exchanger and the lower case, and a support member that supports the heat exchanger toward the lower case.

### CROSS-REFERENCE TO RELATED APPLICATION

This application claims priority to Japanese Patent Application No. 2024-189154 filed on Oct. 28, 2024. The disclosure of the above-identified application, including the specification, drawings, and claims, is incorporated by reference herein in its entirety.

### BACKGROUND

### 1. Technical Field

The present disclosure relates to a power storage device.

### 2. Description of Related Art

Various types of power storage devices have been conventionally proposed. A power storage device that is described in Japanese Unexamined Patent Application Publication No. 2019-067737 (JP 2019-067737 A) includes a housing case, a plurality of battery cells that is disposed in the housing case, and a cooler that is disposed in the housing case. A viscous layer is disposed between the cooler and the battery cells.

### SUMMARY

In the power storage device that is described above, power storage cells may swell and deform by being charged and discharged. At this time, a heat conductive member that is disposed between the cooler and the power storage cells may peel off or cracks may occur within the heat conductive member. Air then enters into the heat conductive member, causing heat conducting capabilities of the heat conductive member to deteriorate. There is a concern that this may cause a problem in which temperature of the power storage cells cannot be adjusted satisfactorily.

The present disclosure has been made in light of the foregoing problems, and an object thereof is to provide a power storage device that is capable of satisfactorily adjusting the temperature of power storage cells.

A power storage device includes at least one power storage cell, a housing case that includes a lower case, and an upper case that is provided such that the lower case is covered from above, the housing case housing the at least one power storage cell, a heat exchanger that is disposed downward from the lower case, a shear panel that is disposed downward from the heat exchanger, a heat conductive member that is disposed in at least one of between the at least one power storage cell and the lower case, and between the heat exchanger and the lower case, and a support member that supports the heat exchanger toward the lower case.

A plurality of liquid medium passages disposed at intervals is fashioned in the heat exchanger, and the support member is fashioned to support a portion of the heat exchanger that is located between the liquid medium passages. The support member is made of urethane foam.

The power storage device further includes a first fixing member for fixing the shear panel, and a second fixing member that is disposed at an interval from the first fixing member, in which the support member is disposed on the shear panel, and the support member is disposed at a middle between the first fixing member and the second fixing member.

A power storage device includes a power storage cell, a heat exchanging member that is disposed downward from the power storage cell, a shear panel that is disposed downward from the heat exchanging member, a heat conductive member that is disposed between the power storage cell and the heat exchanging member, and a support member that is disposed between the shear panel and the heat exchanging member, and that supports the heat exchanging member toward the power storage cell.

According to the power storage device of the present disclosure, the temperature of the power storage cells can be adjusted suitably.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a vehicle 2 that is equipped with a power storage device 1;

FIG. 2 is a plan view illustrating the power storage device 1;

FIG. 3 is a bottom view illustrating the power storage device 1;

FIG. 4 is an exploded perspective view illustrating the power storage device 1;

FIG. 5 is a perspective view illustrating a power storage cell 30;

FIG. 6 is a cross-sectional view illustrating part of the power storage device 1;

FIG. 7 is a cross-sectional view illustrating a heat exchanging unit 23A and configurations therearound;

FIG. 8 is a cross-sectional view taken along line VIII-VIII in FIG. 2;

FIG. 9 is a graph showing temperature distribution during a temperature rise in the power storage device 1 according to a first embodiment;

FIG. 10 is a graph showing temperature distribution during a temperature rise in a power storage device 100 according to a comparative example;

FIG. 11 is a graph showing temperature of power storage cells 30 and limit values of electric power that is charged and discharged by the power storage device 1; and

FIG. 12 is a cross-sectional view illustrating a power storage device 1A according to a second embodiment.

### DETAILED DESCRIPTION OF EMBODIMENTS

Embodiments of the present disclosure will be described with reference to the drawings. Note that in the drawings referred to below, the same or corresponding members are denoted by the same numbers.

### First Embodiment

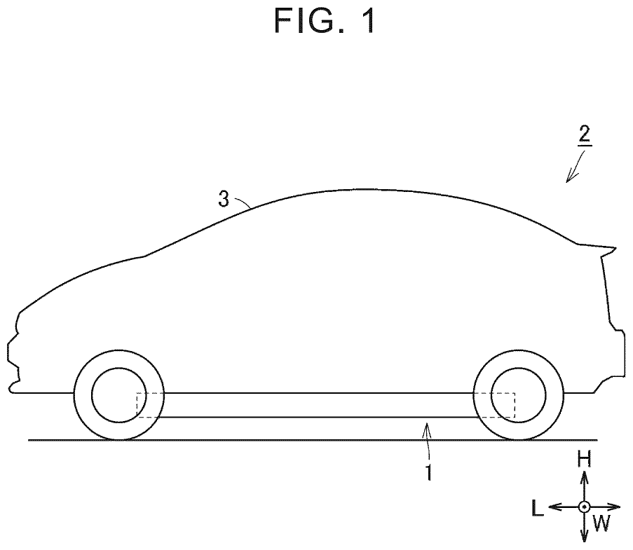

FIG. 1 is a schematic diagram illustrating a vehicle 2 that is equipped with a power storage device 1. The vehicle 2 includes a body 3 and the power storage device 1, and the power storage device 1 is fixed to a lower face of the body 3. Note that in FIG. 1 and other drawings, L indicates a front-rear direction L. H indicates an up-down direction H. Further, W indicates a width direction W.

The body 3 includes a pair of side members disposed spaced apart in the width direction W, and also extending in the front-rear direction L, and a plurality of cross members disposed at intervals in the front-rear direction L and also extending in the width direction W. The power storage device 1 is fixed to, for example, the side members and so forth.

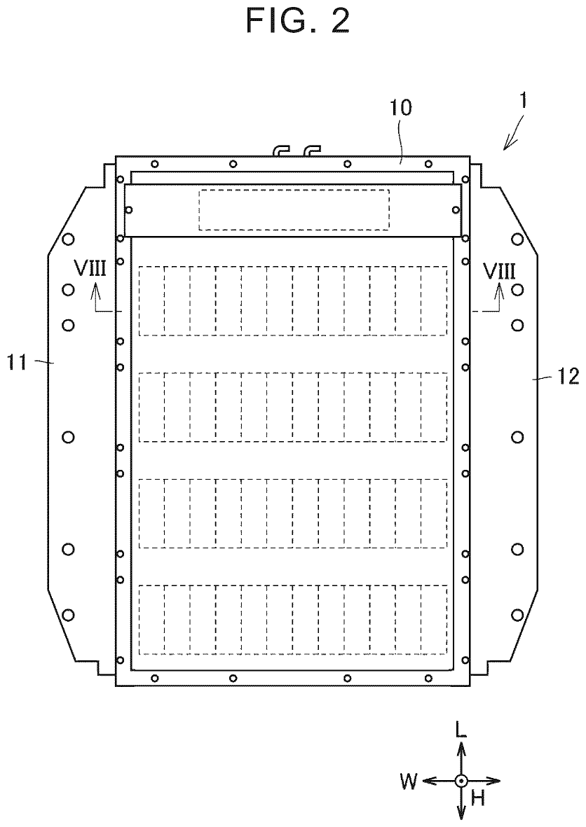

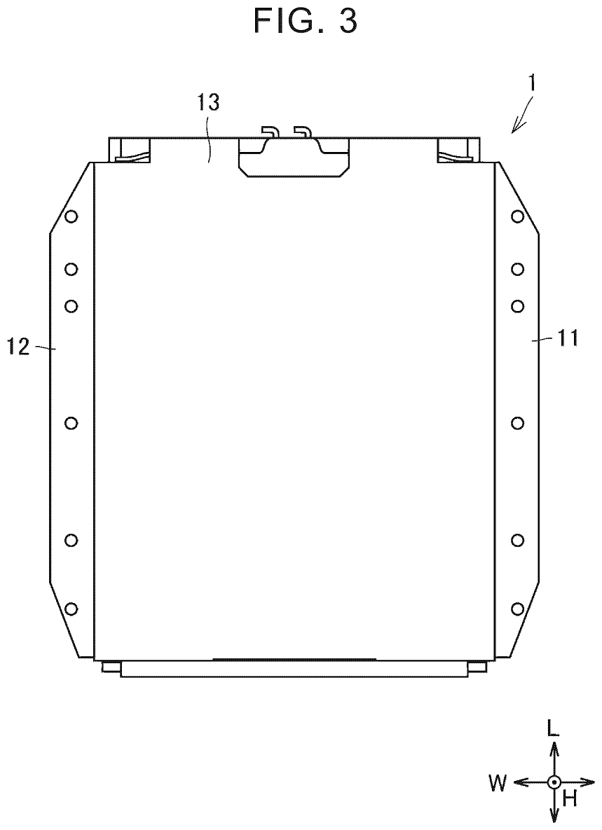

FIG. 2 is a plan view illustrating the power storage device 1. FIG. 3 is a bottom view illustrating the power storage device 1. The power storage device 1 includes a housing case 10, a protective member 11 and a protective member 12, a shear panel 13, and a plurality of support members 18. The protective member 11 and the protective member 12 are disposed on both sides of the housing case 10 in the width direction W. The shear panel 13 is disposed on a lower face side of the housing case 10, and the shear panel 13 is fixed to the protective member 11 and the protective member 12.

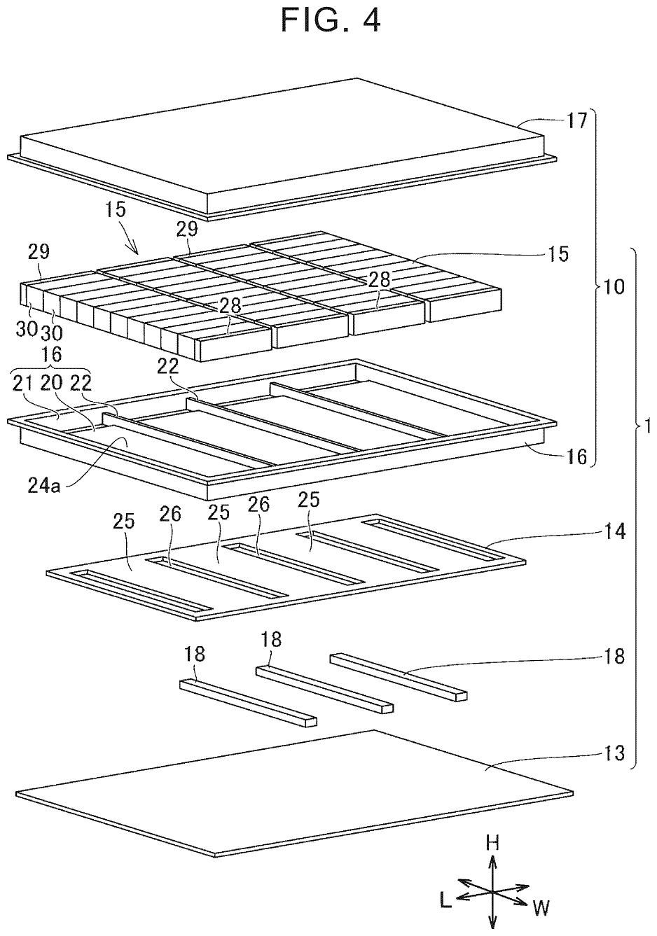

FIG. 4 is an exploded perspective view illustrating the power storage device 1. Note that in FIG. 4, the protective member 11 and the protective member 12 are not illustrated.

In FIG. 4, the power storage device 1 includes the housing case 10, a heat exchanger 14 that is disposed on the lower face of the housing case 10, power storage modules 15 that are housed within the housing case 10, and the shear panel 13 that is described above.

The housing case 10 includes a lower case 16 and an upper case 17. The lower case 16 includes a bottom plate 20, a peripheral wall 21, and a plurality of crossmembers 22. The peripheral wall 21 is formed extending upward from an outer periphery of the bottom plate 20. The crossmembers 22 are disposed on an upper face of the bottom plate 20 and are disposed at intervals in the front-rear direction L. Each of the crossmembers 22 is formed to extend in the width direction W.

The heat exchanger 14 is fixed to a lower face of the bottom plate 20. The heat exchanger 14 includes a plurality of cell heat exchanging units 25. The cell heat exchanging units 25 are disposed at intervals in the front-rear direction L, and the cell heat exchanging units 25 are formed so as to extend in the width direction W. Gaps 26 are formed between the cell heat exchanging units 25. A liquid medium supply pipe and a liquid medium discharge pipe, which are omitted from illustration, are connected to the heat exchanger 14, and a liquid medium flows through the heat exchanger 14.

The shear panel 13 is disposed downward from the bottom plate 20 and the heat exchanger 14. The shear panel 13 is disposed so as to cover the heat exchanger 14.

The support members 18 are disposed on an upper face of the shear panel 13, and are disposed to support the heat exchanger 14 facing the bottom plate 20.

The power storage modules 15 are disposed at intervals in the front-rear direction L. Each of the power storage modules 15 includes a plurality of power storage cells 30 arrayed in the width direction W, and an end plate 28 and an end plate 29. The end plate 28 is located at one end of the power storage module 15, and the end plate 29 is located at the other end of the power storage module 15, in the front-rear direction L. The end plate 28 and the end plate 29 are fixed to the bottom plate 20 of the lower case 16. The power storage cells 30 are restrained between the end plate 28 and the end plate 29.

Each of the power storage cells 30 is formed in a flat rectangular cuboid shape, and the storage cells 30 are formed elongated. The power storage cells 30 are disposed extending in a long manner in the front-rear direction L.

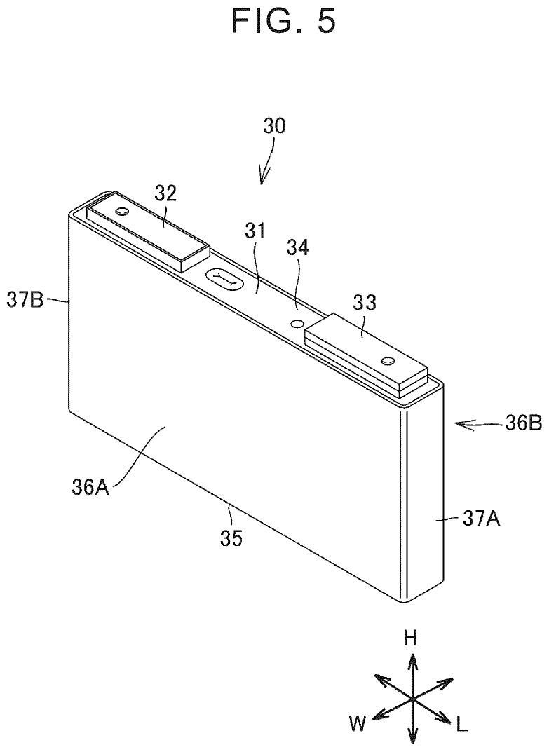

FIG. 5 is a perspective view illustrating a power storage cell 30. The power storage cell 30 includes a cell case 31, an external terminal 32, an external terminal 33, and an electrode assembly that is housed within the cell case 31.

The cell case 31 includes an upper plate 34, a lower plate 35, a main plate 36A and main plate 36B, and an end plate 37A and end plate 37B. The main plate 36A and the main plate 36B are arrayed in the width direction W, and the main plate 36A and the main plate 36B are each formed extending in the front-rear direction L. The end plate 37A and the end plate 37B are arrayed in the front-rear direction L. The external terminal 32 and the external terminal 33 are provided on the upper plate 34.

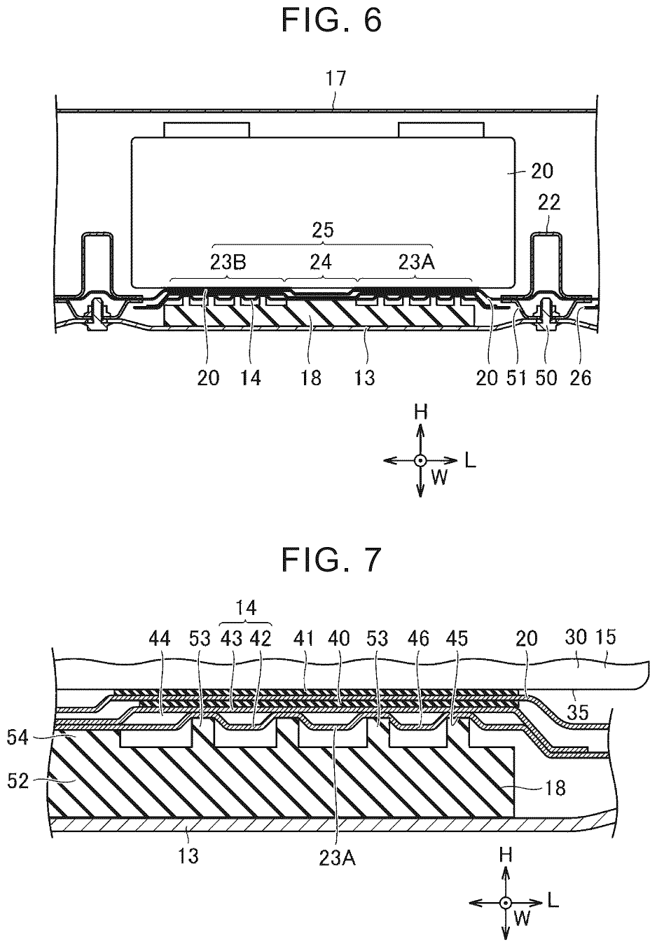

FIG. 6 is a cross-sectional view illustrating part of the power storage device 1. In FIG. 6, the power storage device 1 includes fixing members 50 and brackets 51. The brackets 51 are fixed to the lower face of the bottom plate 20 by welding or the like. The brackets 51 are disposed in the gaps 26 of the heat exchanger 14. Note that the gaps 26 and the brackets 51 are formed to extend in the width direction W, and a plurality of the gaps 26 and of the brackets 51 is provided at intervals in the front-rear direction L. The fixing members 50 fix the shear panel 13 to the brackets 51. Note that, the crossmembers 22 are disposed upward from the bracket 51.

Each of the cell heat exchanging units 25 of the heat exchanger 14 includes a heat exchanging unit 23A and a heat exchanging unit 23B, and a connecting member 24 that is located between the heat exchanging unit 23A and the heat exchanging unit 23B. The heat exchanging unit 23A and the heat exchanging unit 23B are disposed in the front-rear direction L with an interval therebetween. Upper faces of the heat exchanging units 23A and 23B are formed as flat faces.

FIG. 7 is a cross-sectional view illustrating the heat exchanging unit 23A and configurations therearound. The power storage cells 30 are disposed on the upper face of the bottom plate 20, and a heat conductive member 41 is disposed between the storage cells 30 and the bottom plate 20.

The heat exchanger 14 is disposed on the lower face of the bottom plate 20, and a heat conductive member 40 is disposed between the heat exchanger 14 and the bottom plate 20.

The heat conductive member 41 and the heat conductive member 40 are made of a material having high thermal conductivity and also having adhesive properties. Thus, each of the power storage cells 30 is fixed to the upper face of the bottom plate 20 by the heat conductive member 41, and the heat exchanger 14 is fixed to the lower face of the bottom plate 20 by the heat conductive member 40.

The heat exchanger 14 includes a lower plate 42, and an upper plate 43 that is disposed on an upper face of the lower plate 42. A plurality of liquid medium passages 44 is formed between the lower plate 42 and the upper plate 43. The liquid medium passages 44 are disposed at intervals in the front-rear direction L, and are formed extending in the width direction W. The liquid medium passages 44 are formed in each of the heat exchanging unit 23A and the heat exchanging unit 23B.

A plurality of recesses 45 and protrusions 46 are formed on a lower face of the heat exchanging unit 23A. The recesses 45 and the protrusions 46 are alternately formed in the front-rear direction L, and the recesses 45 and the protrusions 46 are formed extending in the width direction W. The liquid medium passages 44 are formed within the protrusions 46. Note that the recesses 45 are formed by bending the lower plate 42 upward.

The support members 18 are disposed on the upper face of the shear panel 13. Specifically, the support members 18 are disposed downward from the power storage cells 30, and between the heat exchanger 14 and the shear panel 13. The support members 18 are made of an elastically deformable material. For example, the support members 18 are made of urethane foam.

Each of the support members 18 includes a base 52, a plurality of protrusions 53, and a middle protrusion 54. The base 52 is fixed to the upper face of the shear panel 13. The protrusions 53 are formed on the upper face of the base 52, and each of the protrusions 53 is formed so as to protrude upward from an upper face of the base 52, with upper ends of the protrusions 53 fitting into the recesses 45, and the protrusions 53 pressing a lower face of the lower plate 42 toward the bottom plate 20 and the power storage cells 30. The protrusions 53 are disposed at intervals in the front-rear direction L, and are disposed in corresponding recesses 45 of the heat exchanging units 23A and 23B.

Each of the recesses 45 is located between the liquid medium passages 44, and each of the protrusions 53 presses the portion of the heat exchanger 14 that is located between the liquid medium passages 44 in the front-rear direction L toward the bottom plate 20 and the power storage cell 30.

The middle protrusion 54 is disposed in the middle of the upper face of the base 52 in the front-rear direction L. The middle protrusion 54 is in contact with the connecting member 24, and presses the connecting member 24 toward the bottom plate 20 and the power storage cell 30.

FIG. 8 is a cross-sectional view taken along line VIII-VIII in FIG. 2. As illustrated in FIG. 8, the power storage device 1 includes a plurality of the support members 18A, 18B, and 18C.

The support members 18A, 18B, and 18C are disposed at intervals in the width direction W. Note that the support members 18A, 18B, and 18C are disposed at equal intervals in the front-rear direction L. The support member 18B is disposed between the support member 18A and the support member 18C. The support member 18A is disposed on the protective member 11 side, and the support member 18C is disposed on the protective member 12 side. That is to say, the support members 18A, 18B, 18C are disposed close to the middle of the power storage module 15 in the front-rear direction L.

In the front-rear direction L, the distance between the support member 18A and the support member 18B is distance D1, and the distance between the support member 18B and the support member 18C is also distance D1. In the front-rear direction L, the distance between the end plate 28 and the support member 18A is distance D2, and the distance between the end plate 29 and the support member 18B is distance D3. Furthermore, the distance D2 is shorter than the distance D1, and the distance D3 is shorter than the distance D1.

In the power storage device 1 that is configured as described above, when the temperature of the power storage cells 30 becomes higher than a first threshold temperature, the heat exchanger 14 is driven and the liquid medium that is cooled to a low temperature flows through the heat exchanger 14. Also, when the temperature of the power storage cells 30 becomes lower than a second threshold temperature, the liquid medium that has been heated to a predetermined temperature flows through the heat exchanger 14. Thus, the heat exchanger 14 can warm or cool each of the power storage cells 30.

In FIG. 7, when the heat exchanger 14 cools or heats the power storage cells 30, the temperature difference between the heat exchanger 14 and the bottom plate 20 becomes great.

For example, when the power storage cells 30 become hot, the liquid medium that is cool flows through the heat exchanger 14, and in some cases this may increase the distance between the bottom plate 20, which expands due to the heat from the storage cells 30, and the heat exchanger 14, which contracts due to the liquid medium that is cool. Even in such a case, the support members 18 press the heat exchanger 14 against the bottom plate 20, and thus can suppress the heat conductive member 40 from peeling off or cracks from occurring within the heat conductive member 40. Also, even when cracks or the like happen to occur in the heat conductive member 40, air can be suppressed from entering inside the heat conductive member 40. This can suppress the heat conducting capabilities of the heat conductive member 40 from deteriorating.

Note that when cooling the power storage cells 30 that have become cold as well, suppressing the heat conductive member 40 from peeling off, cracks from occurring in the heat conductive member 40, and air from entering inside the heat conductive member 40, can be performed in the same way.

When the power storage device 1 that is configured as described above is charged and discharged, each of the power storage cells 30 deforms in an expanding manner. At this time, the power storage modules 15 are fixed to the bottom plate 20 at both ends in the front-rear direction L, and accordingly the power storage modules 15 bend upward and away from the bottom plate 20. Each of the power storage cells 30 is then displaced so as to move away from the bottom plate 20.

The power storage device 1 includes the support members 18 that push the bottom plate 20 upward, and can suppress the heat conductive member 41 that is formed between the bottom plate 20 and the power storage cells 30 from peeling off.

Also, even when cracks, fissures, or the like occur in the heat conductive member 41, the support members 18 press the bottom plate 20 against the power storage cells 30, and accordingly the heat conductive member 41 is compressed. Thus, air can be suppressed from entering inside the heat conductive member 41, and the heat conducting capabilities of the heat conductive member 41 can be suppressed from deteriorating.

In the power storage device 1 that is described above, in FIG. 8, when the power storage module 15 is displaced upward, the middle of the power storage module 15 in the front-rear direction L is readily displaced upward significantly. This is because the power storage module 15 has the end plate 28 and the end plate 29 disposed that are fixed to the bottom plate 20, and the power storage cells 30 are restrained by the end plate 28 and the end plate 29.

The power storage device 1 has the support members 18A, 18B, and 18C that are disposed in the middle in the front-rear direction L. Accordingly, even when the middle portion of the power storage module 15 is displaced upward, the support members 18A, 18B, and 18C push the heat exchanger 14 and the bottom plate 20 up against the power storage cells 30. Thus, cracks can be suppressed from occurring in the heat conductive member 40 and air can be suppressed from entering inside the heat conductive member 40.

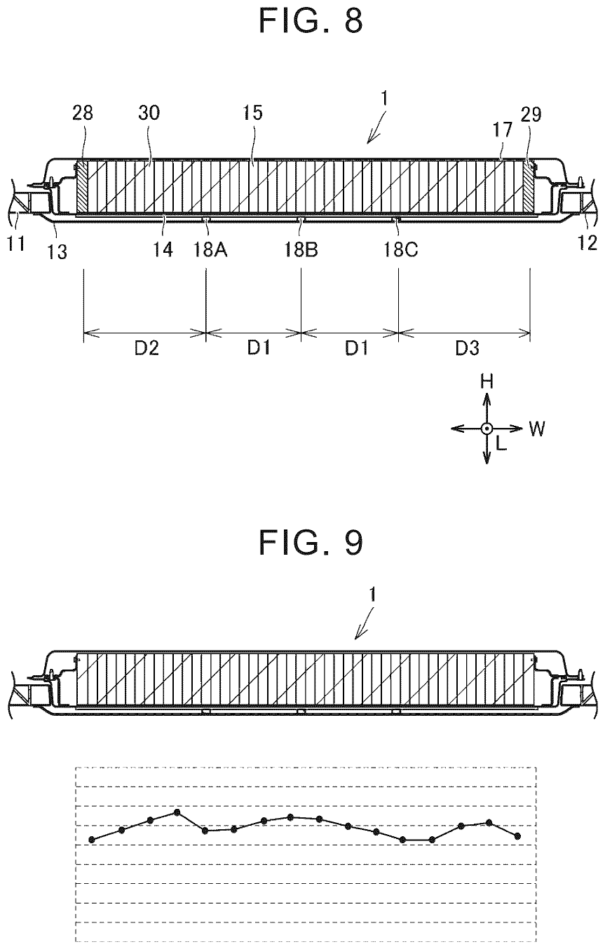

A comparison result between a power storage device 100 according to a Comparative Example and the power storage device 1 according to the first embodiment will be described with reference to FIGS. 9 to 11, and so forth.

The power storage device according to the Comparative Example is configured similarly to the power storage device 1 according to the first embodiment, except for a point of not including the support members 18 described above.

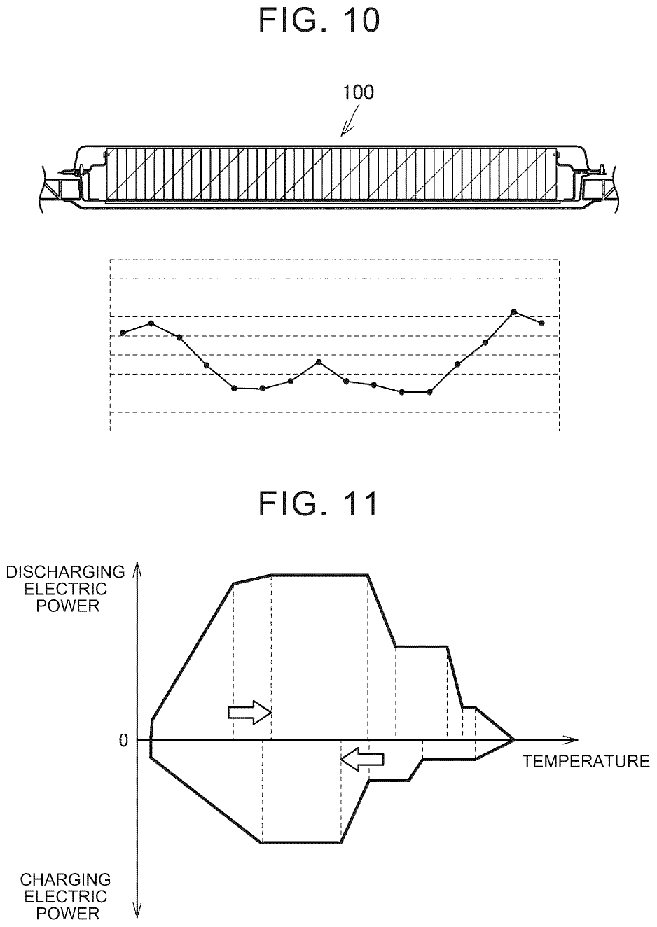

FIG. 9 is a graph showing temperature distribution during a temperature rise in the power storage device 1 according to the first embodiment. FIG. 10 is a graph showing temperature distribution during a temperature rise in the power storage device 100 according to the Comparative Example. In both FIGS. 9 and 10, the horizontal axis indicates the position of the power storage cells 30 that are arrayed in the front-rear direction L, and the vertical axis indicates the temperature of each of the power storage cells 30.

As can be seen from FIGS. 9 and 10, the power storage device 1 according to the first embodiment can raise the temperature of the power storage modules 15 over the front-rear direction L.

FIG. 11 is a graph showing the temperature of the power storage cells 30 and limit values of the electric power charged and discharged by the power storage device 1. As shown in FIG. 11, when the temperature of the power storage cells 30 become lower or higher, an absolute value of the limit value of the discharging electric power and an absolute value of the limit value of the charging electric power of the power storage device 1 become smaller.

On the other hand, in the power storage device 1 according to the first embodiment, the heat conducting capabilities of the heat conductive members 40 and 41 can be maintained, and the temperature of the power storage cells 30 can be kept within a predetermined range. Thus, the charging and discharging electric power of the power storage device 1 can be suppressed from being restricted.

### Second Embodiment

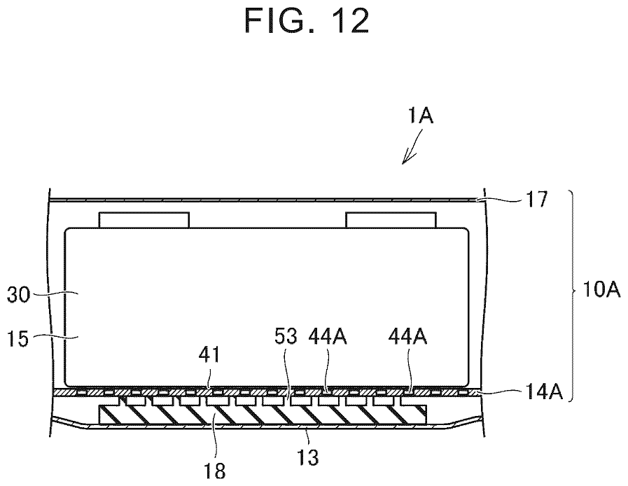

A power storage device 1A according to a second embodiment will be described with reference to FIG. 12. This power storage device 1A is configured in the same way as the power storage device 1 according to the first embodiment, except for a configuration in which the heat exchanger 14 is integrally formed with the bottom plate 20.

FIG. 12 is a cross-sectional view illustrating a power storage device 1A according to a second embodiment. The power storage device 1A includes a housing case 10A. The housing case 10A includes the upper case 17, and a bottom plate of a lower case of the housing case 10A is a heat exchanging member 14A. The heat exchanging member 14A is formed in a plate-like shape. The peripheral wall 21 is formed extending upward from an outer periphery of the heat exchanging member 14A.

An upper face of the heat exchanging member 14A is formed as a flat face, and the upper face of the heat exchanging member 14A defines a housing space for housing the power storage modules 15 and the like. The heat exchanging member 14A has a plurality of liquid medium passages 44A formed therein. The liquid medium passages 44A are each formed at intervals in the front-rear direction L.

The power storage device 1A includes the support member 18, and protrusions 53 of the support member 18 are in contact with portions of the heat exchanging member 14A that are situated between the liquid medium passages 44A. The heat exchanging member 14A is thus pushed up toward the power storage cells 30.

Accordingly, the heat conductive member 41 that is disposed between the upper face of the heat exchanging member 14A and the power storage module 15 can be suppressed from peeling off or the like.

The embodiment that is disclosed herein should be considered to be exemplary in all respects and not restrictive. The scope of the present disclosure is set forth by the claims, and it is intended to include all modifications within the meaning and scope of the claims.

What is claimed is:

1. A power storage device, comprising:
at least one power storage cell;
a housing case that includes a lower case, and an upper case that is provided such that the lower case is covered from above, the housing case housing the at least one power storage cell;
a heat exchanger that is disposed downward from the lower case;
a shear panel that is disposed downward from the heat exchanger;
a heat conductive member that is disposed in at least one of between the at least one power storage cell and the lower case, and between the heat exchanger and the lower case; and
a support member that supports the heat exchanger toward the lower case.

2. The power storage device according to claim 1, wherein
a plurality of liquid medium passages disposed at intervals is fashioned in the heat exchanger, and
the support member is fashioned to support a portion of the heat exchanger that is located between the liquid medium passages.

3. The power storage device according to claim 1, wherein the support member is made of urethane foam.

4. The power storage device according to claim 1, further comprising:
a first fixing member for fixing the shear panel; and a second fixing member that is disposed at an interval from the first fixing member, wherein
the support member is disposed on the shear panel, and
the support member is disposed at a middle between the first fixing member and the second fixing member.

5. A power storage device, comprising:
a power storage cell;
a heat exchanging member that is disposed downward from the power storage cell;
a shear panel that is disposed downward from the heat exchanging member;
a heat conductive member that is disposed between the power storage cell and the heat exchanging member; and
a support member that is disposed between the shear panel and the heat exchanging member, and that supports the heat exchanging member toward the power storage cell.
